(19) United States
(12) Patent Application Publication
(10) Pub. No.: US 2026/0175259 A1
(43) Pub. Date: Jun. 25, 2026

(54) DEVICE TO SEPARATE OVERSIZED PARTICLES DURING FIELD POWDER TRANSFER

(71) Applicant: Downhole Chemical Solutions, LLC, Frisco, TX (US)

(72) Inventors: Zachary West, Youngsville, LA (US); Jacob Deshotels, Lafayette, LA (US); Jobe Hebert, Lafayette, LA (US)

(73) Assignee: Downhole Chemical Solutions, LLC, Frisco, TX (US)

(21) Appl. No.: 19/430,126

(22) Filed: Dec. 22, 2025

Related U.S. Application Data
(60) Provisional application No. 63/736,818, filed on Dec. 20, 2024.

(51) Int. Cl. B07B 1/40

(52) U.S. Cl. CPC B07B 1/40

(57) ABSTRACT

A system and method is disclosed that provides a much-improved portable and mobile device for removing oversized particles in powdered polyacrylamide in the field. The system comprises an inline screen or sieve with an external vibratory action, mounted within a vessel and piped in line with powder flow for conveying dry polymer from within a portable powder transport container into a second container or end-use process. The sifting unit is mounted in an uneven plane or orientation relative to the flow of dry powder when transferring the powder from one powder-holding vessel to another powder-holding vessel or process. The dry solids larger than the preselected mesh opening in the screen or sieve are directed off the screen or sieve into a separate container or bag, while the solids smaller than the mesh opening flow through the screen to the receiving container or process.

### CROSS REFERENCE TO RELATED APPLICATIONS

This is a non-provisional U.S. patent application claiming priority to provisional U.S. patent application No. 63/736,818 filed on Dec. 20, 2024, having the title “Device to Separate Oversized Particles During Field Powder Transfer”. The contents of the above-referenced application are incorporated herein by reference.

### FIELD

The present invention generally relates to material separation, particularly an inline screen or sifting apparatus operating with or without external vibratory action. The separating screen is positioned at a non-perpendicular angle across the flow of dry powder from one powder-holding vessel to another powder-holding vessel or process. The separation of particular dry solids larger than the desired preselected mesh opening in the screen or sieve is directed off the screen or sieve and conveyed by gravity into a separate container or bag.

### BACKGROUND

The use of dry powdered polymers such as polyacrylamide offers many benefits in the well-completion industry. Dry polyacrylamide offers extended storage and a shelf life of up to two years in cool, ventilated storage. This is significantly longer than the shelf life of liquid-emulsified polyacrylamide solutions, which are more prone to degradation and usually require use within three months after preparation.

Dry polyacrylamide powder offers further advantages: it is less susceptible to microbial growth and enzymatic degradation, does not require non-standard packaging and bulky watertight containers, and is more concentrated, requiring fewer delivery cycles for a given well completion. This makes it generally more cost-effective than liquid emulsions or solutions.

Dry polyacrylamide additionally has a reduced environmental impact compared to liquid forms, which can spill and spread quickly and often form emulsions requiring surfactants and/or oils to inhibit, which can exacerbate the environmental impact. Handling dry powder reduces the risk of exposure to acrylamide monomers, which are more prevalent in liquid forms. Proper storage and handling of the dry powder minimizes the risk of inhalation or skin contact, making it safer for workers.

The dry polymer can be added directly to the well-completion fluid using specialized equipment, such as the DriFlow™ powder dispersion process provided by Downhole Chemical Solutions, LLC and described by U.S. Pat. No. 10,737,226, the contents of which are incorporated here by reference. Utilizing powdered polyacrylamide allows for greater control over the dosage in water, which is particularly helpful in applications such as well-completion and well-fracture operations.

Due to its hygroscopic nature, it is understood how dry, high molecular weight polyacrylamide can demonstrate high water absorption and retention capacity. This means polyacrylamide can readily absorb moisture from the surrounding environment, even the air. When exposed to humid air conditions, the surface of the polyacrylamide particles begins to attract and hold water molecules.

As moisture is absorbed, thin layers of water form on the surface of the polyacrylamide particles. These water layers can create liquid bridges between adjacent particles. These liquid bridges increase the adhesive forces between the particles, causing them to stick together and form larger agglomerates.

In addition to liquid bridges, capillary condensation can occur within the pores and interstitial spaces between particles. The phenomenon happens when the relative humidity is high enough to cause condensation of water vapor in the tiny capillaries formed by the closely packed particles. The negative capillary pressure generated by this condensation further enhances the cohesive forces, forming larger agglomerates.

Over time, the absorbed moisture can form solid bridges if the water evaporates and leaves behind dissolved substances that recrystallize. Additionally, the particles can absorb water molecules on their surfaces, creating thin adsorption layers that contribute to the agglomeration process.

This agglomeration of polyacrylamide particles due to moisture adsorption can have several practical implications. The formation of larger agglomerates can complicate the storage and handling of the powder, making it more difficult to achieve uniform dispersion when preparing solutions or applying the powder to various processes. The agglomerated particles may not dissolve as readily or uniformly as the original fine powder, potentially affecting the performance of the polyacrylamide in applications such as well fracture and well completion and water treatment, where precise dosing and rapid dissolution are critical.

Several filtration and separation methods can be employed to remove dry polymer agglomerates from the bulk flow of the fine polyacrylamide powder during transfer from one storage container to another or into a process for dissolving the fine powder. These methods are intended to transfer only the desired fine particles, while larger agglomerates are removed.

It is a common practice to use sieving and screening devices. These devices may use vibration to move the powder across a screen with a specific mesh or opening size. The vibration helps break up some softer agglomerates and allows fine particles to pass through while retaining larger agglomerates on the screen. Vibratory screeners are effective for continuous processing and can handle large volumes of powder in a period.

Vibration screens play a crucial role in material separation and particle sizing. These screens operate by harnessing the power of vibrations produced by an electric motor with an unbalanced mass. As these vibrations propagate, they induce oscillatory motion in a horizontally oriented mesh, enabling the effective movement and segregation of materials based on their particle size. The separation process can be optimized to cater to varying materials and particle sizes by fine-tuning the amplitude and frequency of these vibrations.

High-energy screeners like the Hi-Sifter system use intense vertical energy to cause powders to jump on the screen surface. The high energy helps to break down agglomerates and allows fine particles to pass through the desired screen. This method is effective for deagglomerating powders that have picked up moisture or become compressed.

However, it is not always feasible to include such systems in small-scale or mobile operations where the oscillations or energy requirements would be prohibitive. A need therefore exists for a vibratory screener configuration which can operate in a much more spatially and energetically constrained environment.

Another disadvantage of a horizontally oriented screen, in which the deck IS substantially flat, is that larger particles of material being screened tend to remain in a fixed orientation as the screen separates the larger particles. Screens therefore use larger surface areas and more intense vibratory energy to achieve acceptable separation, often involving multiple layers of ever smaller openings to achieve acceptable throughput.

One aspect of the invention involves positioning the screening device at the point of use, or immediately adjacent to it, to ensure that the polyacrylamide powder is screened just before it is needed. This minimizes the time between screening and use, reducing the risk of re-agglomeration due to local environmental factors such as humidity in the air, and enables continuous operation and a steady supply of fine, properly sized polyacrylamide particles, enhancing the efficiency of the downstream processes and reducing wear on other components.

In an embodiment, the separation device is positioned in a powder flow conduit conveying powder from one powder container to another or into downstream powder dispersion processes. Doing this integrates the vibratory screen into the product transfer line. This position of the separation device allows for continuous screening and separation of materials as they are conveyed from one point to another in the powder transfer process. This seamless incorporation is particularly advantageous for a powder transfer process that requires high cleanliness levels and where contamination control is critical.

In an embodiment, the invention filters powdered polyacrylamide friction reducers and viscosity builders upstream of a water mixing device. However, it is not limited to working solely with friction reducers and/or viscosifying polymers. It can also be used with various chemical additives commonly used in well drilling, completion, water treatment, and fracture operations.

Unlike current sifting systems and methods, this invention uses an inclined plane and a pneumatic or electric vibration device to orient the sifting screen. This method uses far less intense vibratory action to aid the separation process. The sifting system in this invention is positioned in an inclined plane from 10 degrees to 60 degrees relative to the flow of dry powder when transferring the powder from one powder-holding vessel to another powder-holding vessel or process.

### SUMMARY OF THE INVENTION

The present invention provides a much-improved portable and mobile device for removing oversized particles in powdered polyacrylamide in the field. The invention employs an enclosed in-line screen, which may be fabricated from any suitable material (stainless steel, high-density plastic, nylon, synthetic fabrics) in any appropriate shape or thickness.

In an embodiment, the present invention comprises an inline screen or sieve with or without external vibratory action, mounted within a vessel and piped in line with powder flow for conveying dry polymer from within a portable powder transport container into a second container or end-use process. The sifting unit is mounted in an uneven plane or orientation relative to the flow of dry powder when transferring the powder from one powder-holding vessel to another powder-holding vessel or process. The dry solids larger than the preselected mesh opening in the screen or sieve are directed off the screen or sieve into a separate container or bag, while the solids smaller than the mesh opening flow through the screen to the receiving container or process.

In an embodiment, a small vibratory system (powered by pneumatic, electric, or other suitable power) can be physically attached to the external surface of the body of the sifting device. If the product requires it, the added vibration helps dislodge larger particle size product from the screen, where it is then routed to an external container to store the undesirable larger particles.

### BRIEF DESCRIPTION OF DRAWINGS

In the detailed description of embodiments usable within the scope of the disclosure presented below, reference is made to the accompanying drawings:

FIGS. 1A-1C are three perspective views of an embodiment of the invention.

### DETAILED DESCRIPTION OF THE EMBODIMENTS

Before describing selected embodiments of the present disclosure in detail, it is to be understood that the present invention is not limited to the embodiments described herein. The disclosure and description herein are illustrative and explanatory of one or more presently preferred embodiments and variations thereof. It will be appreciated by those skilled in the art that various changes in the design, organization, order of operation, means of operation, equipment structures and location, methodology, and use of mechanical equivalents may be made without departing from the spirit of the invention.

As well, it should be understood the drawings are intended to illustrate and plainly disclose presently preferred embodiments to one of skill in the art, but are not intended to be manufacturing level drawings or renditions of final products and may include simplified conceptual views as desired for easier and quicker understanding or explanation. As well, the relative size and arrangement of the components may differ from that shown and still operate within the spirit of the invention.

Moreover, it will be understood that various directions such as “upper,” “lower,” “bottom,” “top,” “left,” “right,” and so forth are made only concerning explanation in conjunction with the drawings and that the components may be oriented differently, for instance, during transportation and manufacturing as well as operation. Because many varying and different embodiments may be made within the scope of the concept(s) herein taught, and because many modifications may be made in the embodiments described herein, it is to be understood that the details herein are to be interpreted as illustrative and non-limiting.

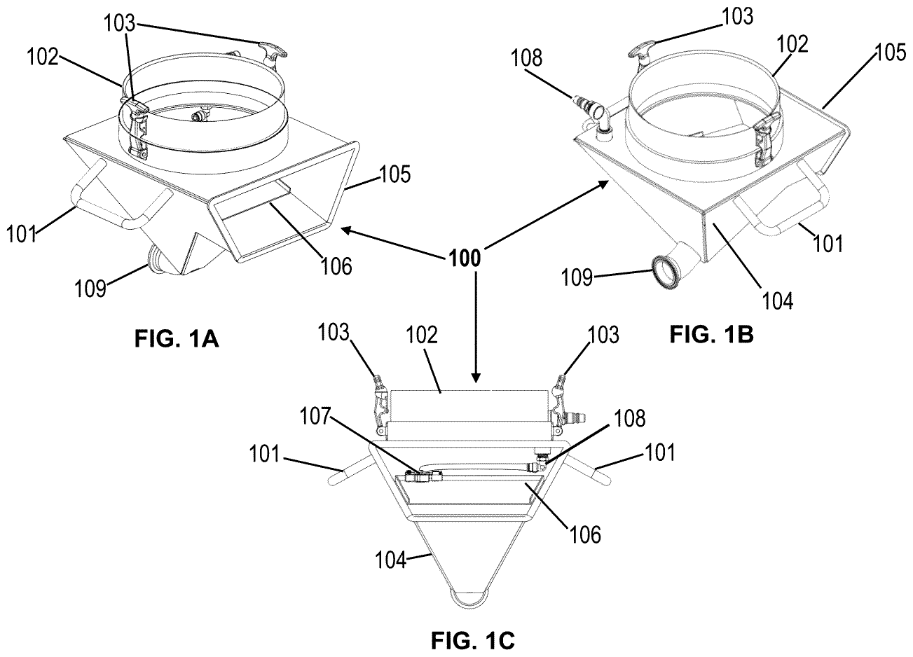

FIGS. 1A-1C illustrate a preferred embodiment of the sifter 100. The sifter 100 comprises a central body equipped with handles 101 configured to enable manual lifting, installation, and removal of sifter 100. A downspout attachment 102, affixed with downspout latches 103, is adapted to receive powder material from an augering mechanism or feeder conduit. In the preferred embodiment, downspout attachment 102 is generally cylindrical and axially aligned with, and removably coupled to, the feeder conduit or augering mechanism; however, alternative geometries may be employed as needed. Screen 106 is located above funnel 104 and adjacent to trash chute 105. Screen 106 is interchangeable and may be, for example, wire mesh or perforated plate. In use, the mesh size is selected based on the required particle size separation. In use, screen 106 is excited by vibrating motor 107 which may operate at adjustable frequencies (e.g., about 20 to about 60 Hz) and amplitudes to produce multi-directional oscillations, and therefore oscillates to filter the smaller dry powder material through the mesh, into funnel 104, where it is conveyed through hose clamp 109 and into the secondary container or a downstream process that receives and utilizes the smaller dry powder material. In an embodiment, sifter 100 includes air attachment 108 extending through the body for connecting a pneumatically actuated vibrating motor 107 to the screen. However, it can be appreciated that alternative embodiments may employ, for example, an electrically powered vibration motor utilizing a battery or other external power connection rather than a pneumatic connection.

In a method embodiment, fine powder is delivered to the well completion site in conically shaped powder transport containers for transferring the fine powdered polymer product into a secondary container or downstream process, such as at the well completion site. The powder transport container discharges powder by gravity out the bottom via a valve directly into the sifter, which is activated to oscillate and separate the larger particles, directing them through the trash chute into a side-mounted receptacle or bag for reprocessing or discarding. The powder flow rate over and through the sifting screen is controlled manually or by a computer, such as via a PLC system that adjusts vibration intensity and duration based on powder characteristics, to ensure consistent throughput and particle size separation.

While specific embodiments of the invention have been described in detail and shown by way of example, modifications and alternative forms will be appreciated by those of ordinary skill in the art.

What is claimed is:

1. A screening device for filtering a fine powder, comprising:
a central body;
a downspout attachment connected to the central body;
the downspout attachment further connected to a feeder conduit;
the downspout attachment adapted to receive the powder from the feeder conduit;
a screen positioned downstream the feeder conduit and downstream the downspout attachment in the central body;
a vibration mechanism configured to oscillate the screen to filter oversized particles from the fine powder;
a funnel positioned downstream the screen; and
the funnel configured to convey the fine powder downstream to a collection receptacle.

2. The screening device of claim 1, wherein the vibration mechanism is an electric motor, capable of generating adjustable vibration frequencies.

3. The screening device of claim 2, wherein the vibration frequencies range from about 20 (Hz) to about 60 (Hz).

4. The screening device of claim 1, wherein the vibration mechanism is a pneumatic motor capable of generating adjustable vibration frequencies.

5. The screening device of claim 4, wherein the vibration frequencies range from about 20 Hz to about 60 Hz.

6. The screening device of claim 4, further comprising an air attachment extending through the central body for connecting the pneumatic motor to the screen.

7. The screening device of claim 1, further comprising:
a set of downspout latches connected to the downspout attachment; and
wherein the downspout attachment is removably connected to the feeder conduit via the downspout latches.

8. The screening device of claim 1, wherein the screening device is positioned adjacent to the collection receptacle.

9. The screening device of claim 8, wherein the screen is positioned adjacent to a disposal receptacle.

10. The screening device of claim 1, wherein the screen is a mesh screen.

11. The screening device of claim 10, wherein the screen in interchangeable.

12. The screening device of claim 1, wherein the device is mounted on an uneven plane relative to the flow of the powder.

13. A method for filtering fine powder material using a vibratory screening device, comprising the steps of:
positioning the vibratory screening device adjacent to a collection receptacle;
loading a powder material onto a screen located within the vibratory screening device;
activating a vibration mechanism to induce a vibratory motion in the screen to oscillate the screen to filter oversized particles from the fine powder material;
collecting the filtered fine powder material in a collection receptacle; and
discharging the oversized particles from the screen;

14. The method of claim 13, further comprising:
determining an optimal vibration frequency to optimize the separation efficiency of the fine powder material from the oversized particles; and
adjusting the vibratory motion of the screen to the optimal vibration frequency.

15. The method of claim 14, wherein the step of adjusting the vibratory motion of the screen to the optimal vibration frequency further comprises:
adjusting the optimal vibration frequency from about 20 Hz to about 60 Hz.

16. The method of claim 13, further comprising:
providing the vibratory screening device with a downspout attachment having a set of downspout latches; and
removably connecting the downspout attachment to a feeder conduit via the set of downspout latches.
The method of claim 13, further comprising:
moving the vibratory screening device to a second position located adjacent to a second collection receptacle.

17. The method of claim 13, wherein the step of activating a vibration mechanism to induce vibratory motion in the screen to oscillate the screen to filter oversized particles from the fine powder is provided via a pneumatic motor.

18. The method of claim 13, wherein the step of activating a vibration mechanism to induce vibratory motion in the screen to oscillate the screen to filter oversized particles from the fine powder is provided via an electric motor.

19. A mobile screening device for filtering a polyacrylamide powder comprising:
a central body;
a downspout attachment connected to the central body;
a set of downspout latches connected to the downspout attachment;
the downspout attachment adapted to receive the polyacrylamide powder from a feeder conduit;
the downspout attachment removably connected to the feeder conduit via the downspout latches;
wherein the downspout attachment is axially aligned with the feeder conduit;
a mesh screen positioned downstream the feeder conduit and downstream the downspout attachment;
an air attachment extending through the central body for connecting a pneumatic motor to the screen.
the pneumatic motor configured to oscillate the mesh screen from about 20 Hz to about 60 Hz to filter oversized particles from a fine polyacrylamide powder;
a funnel positioned downstream the screen;
the funnel configured to convey the fine polyacrylamide powder downstream to a first collection receptacle adjacent the mobile screening device; and
wherein the mobile screening device is capable of being transported to a position adjacent a second collection receptable.
